(19) United States
(12) Patent Application Publication
(10) Pub. No.: US 2009/0276608 A1
(43) Pub. Date: Nov. 5, 2009

(54) MICRO PROCESSOR, METHOD FOR ENCODING BIT VECTOR, AND METHOD FOR GENERATING BIT VECTOR

(75) Inventors: Hajime Shimada, Anjyo-shi (JP); Shinobu Miwa, Koganei-shi (JP); Shinji Tomita, Kyoto-shi (JP)

Correspondence Address: Gerald E. Hespos;CASELLA & HESPOS LLP, Suite 1703, 274 Madison Avenue, New York, NY, 10016, US

(73) Assignee: KYOTO UNIVERSITY, Kyoto-shi (JP)

(21) Appl. No.: 12/183,123

(22) Filed: Jul. 31, 2008

(30) Foreign Application Priority Data
Jan. 29, 2008 (JP) 2008-017363

(51) Int. Cl. G06F 9/30

(52) U.S. Cl. 712/216; 712/E09.016

(57) ABSTRACT

In a microprocessor for pipeline processing instruction execution, dependency relationship information representing a dependency relationship of each of a plurality of instructions with all the preceding instructions is stored, and whether or not the instructions in stages after instruction issue depend on the instruction of a miss speculation is judged based on the dependency relationship information if the miss speculation occurs during the execution of the plurality of instructions in accordance with a set schedule. Thus, this microprocessor can perform a recovery processing for invalidating only the instructions in a dependency relationship at once in the case of a miss speculation in speculative scheduling.

### BACKGROUND OF THE INVENTION

1. Field of the Invention

The present invention relates to a microprocessor for pipeline processing the execution of instructions and particularly to a microprocessor capable of more properly performing a recovery processing in the case of a miss speculation. The present invention also relates to a method for encoding a bit vector and a method for generating a bit vector, which are suitably used in this microprocessor.

2. Description of the Background Art

One technique for speeding up an instruction execution of a microprocessor (MPU) is a pipeline processing. Generally, the microprocessor firstly fetches an instruction (machine instruction) (fetches an instruction from a memory), secondly decodes the instruction (interprets the meaning of the instruction), thirdly reads data necessary for operation, fourthly operates (calculates) and fifthly writes the operation result (data) to execute the instruction. In this pipeline processing, the process of the instruction execution is divided into a plurality of stages and the processings in the above respective stages are performed in parallel. Thus, a plurality of instructions can be executed in parallel while shifting time, wherefore the processing efficiency of the microprocessor improves. For example, in the above example, a fetch unit, a decode unit, a data read unit, an execution unit and a unit for writing the operation result are independently constructed, the microprocessor is constructed to provide units for temporarily storing data such as flip-flops between the these respective units, and the instruction is divided into five stages, whereby the pipeline processing for performing the processings in the respective stages in parallel can be performed.

Depending on the construction of the microprocessor for performing the pipeline processing, there are a payload RAM read stage (“Payload”) for reading information of an instruction from a payload RAM storing the information of the instruction and a register read stage (“Reg.”) for reading data from a resistor after an instruction issue stage (“Issue”) in such a microprocessor, there are cases where an instruction execution stage (“Exec”) is entered after several cycles following the issue of an instruction. Here, a latency (number of executed cycles) from the issue of the instruction to the instruction execution is called an “instruction issue latency). For example, in the case of “Issue”→“Payload”→>“Reg.”→“Exec”, three cycles of “Issue”→“Payload”→“Peg.” are the instruction issue latency. Such an instruction issue latency is, for example, seven cycles in the case of Pentium 4 (product name) manufactured by Intel.

In a microprocessor having such an instruction issue latency, a succeeding instruction needs to be issued before a preceding instruction enters the execution stage in the pipeline processing. If instructions have a fixed instruction execution latency (number of cycles required for the processing in the instruction execution stage), a succeeding instruction can enter the execution stage at a timing at which the execution of a preceding instruction ends if the succeeding instruction is issued at a timing delayed by the execution latency after the preceding instruction is issued. However, if the execution latency of a preceding instruction is not fixed, e.g. if the preceding instruction has an execution latency which changes depending on whether to hit or to miss a cache such as a load instruction, it is difficult to schedule the succeeding instruction.

Scheduling methods for an instruction dependent on a load instruction include a scheduling method for issuing a succeeding instruction i2 after judging whether a cache has been hit or missed by executing a preceding instruction i1, for example, as shown in FIG. 1A. This scheduling method can reliably execute the succeeding instruction i2, but a plurality of instructions i1, i2 in a dependency relationship cannot be successively executed as can be understood from FIG. LOA. Thus, the processing efficiency of the microprocessor decreases. Accordingly, as shown in FIG. 10B, there is a speculative scheduling method for issuing succeeding instructions i2 to i4 by assuming (predicting) the operation result of the preceding instruction i1, i.e. assuming (predicting) that the cache memory is hit, for example, in the case of a load instruction. Although this speculative scheduling method can successively execute a plurality of instructions i1 to i4 in a dependency relationship, the succeeding instructions i2 to i4 cannot be executed in the case of a failure in assumption (prediction) (miss speculation), for example, in the case of a cache miss in the above example. This necessitates a recovery processing for recovering the instruction execution from the miss speculation of the speculative scheduling.

As one of such recovery processings, there is a method for rescheduling all the instructions issued during cycles in which instruction(s) dependent on a load instruction was possibly issued, for example, upon a miss speculation of an instruction dependent on the load instruction. Such a method is disclosed, for example, in “Kessler, R.: “The Alpha 21264 Microprocessor”, IEEE Micro, Vol. 19, No. 2, pp. 22-36 (1999)” (D1).

For example, there is also a method for successively invalidating dependencies between instructions by following them in order. Such a method is disclosed, for example, in “Toshinori Sato: “Improving Efficiency of Dynamic Speculation via Data Address Prediction using instruction Reissue Mechanism”, Information Processing Society of Japan, Vol. 40, No. 5, pp. 2093-2108 (1999)” (D2).

In speculative scheduling, as shown in FIG. 10B, there are not only the case where the succeeding instruction i2 directly uses the operation result of the preceding instruction i1 in a dependency relationship, but also the case where the succeeding instructions i3, i4 indirectly use the operation result of the preceding instruction i1 via the instruction i2 or via the instructions i2 and i3. In other words, the succeeding instructions i3, i4 dependent on the succeeding instruction i2 could be issued. In the case of such an instruction having a complicated dependency relationship, invalidation is difficult. Conventionally, it has been obliged to select either the invalidation of all the instructions including those having no dependency relationship as in the recovery processing disclosed in D1 or the sequential invalidation of dependencies between instructions, following them in order as disclosed in D2.

### SUMMARY OF THE INVENTION

In view of the above situation, an object of the present invention is to provide a microprocessor capable of performing a recovery processing for invalidating only instructions in a dependency relationship at once in the case of a miss speculation in speculative scheduling. Another object of the present invention is to provide a method for encoding a bit vector and a method for generating a bit vector, which are suitably used in this microprocessor.

In a microprocessor according to the present invention for pipeline processing the execution of instructions, dependency relationship information representing a dependency relationship of each of a plurality of instructions with all the preceding instructions is stored, and it is judged whether or not the instructions in stages after instruction issue depend on the instruction of a miss speculation based on the dependency relationship information if the miss speculation occurs during the execution of the plurality of instructions in accordance with a set schedule. Thus, the microprocessor of the present invention can perform a recovery processing for invalidating only the instructions in a dependency relationship at once in the case of a miss speculation in speculative scheduling.

In a method for encoding a bit vector according to the invention, the bit vector is comprised of a bit string indicating whether or not each bit is in a dependency relationship with an instruction of an entry number of an instruction window corresponding to the bit number of the bit. In a method for generating a bit vector according to the invention, the bit vector is generated by taking a logical sum of bit vectors of instructions in a dependency relationship with the instruction of the bit vector. Thus, the bit vector encoding method and the bit vector generating method of the present invention are suitably applied to the above microprocessor and the dependency relationship between the instructions can be obtained by a relatively simple computation.

These and other objects, features and advantages of the present invention will become more apparent upon a reading of the following detailed description with reference to accompanying drawings.

### BRIEF DESCRIPTION OF THE DRAWINGS

FIG. 1 is a block diagram showing the construction of a microprocessor according to one embodiment of the invention,

FIG. 2 is a table showing a method for generating a bit vector in the embodiment,

FIG. 3 is a diagram showing the configuration of a register map table in the embodiment,

FIG. 4 is a diagram showing the configuration of a reissue matrix table in the embodiment,

FIG. 5 is a block diagram showing an exemplary construction of a reissue matrix table unit,

FIG. 6 is a circuit diagram showing 1-bit cells in the reissue matrix table shown in FIG. 5,

FIG. 7 is a circuit diagram showing an exemplary construction of a bit vector comparator unit,

FIG. 8 is a diagram (No. 1) showing a simulation result,

FIG. 9 is a diagram (No. 2) showing a simulation result, and

FIG. 10 is a diagram showing the scheduling of instructions dependent on a load instruction.

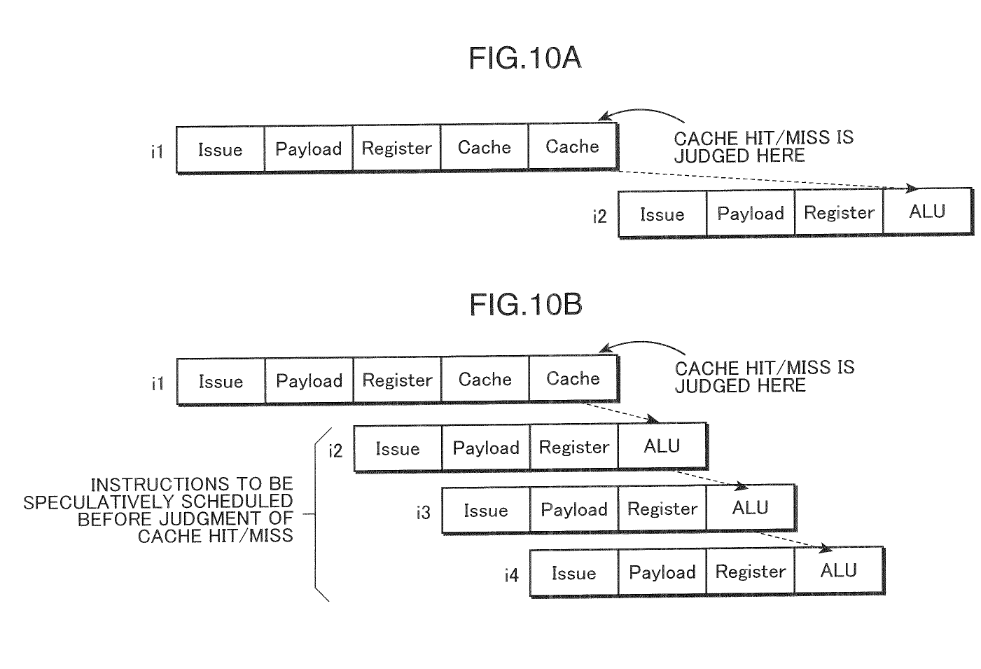

### DESCRIPTION OF THE PREFERRED EMBODIMENTS

Hereinafter, one embodiment of the present invention is described with reference to the accompanying drawings. Constructions identified, by the same reference numerals in the respective figures are identical and not repeatedly described.

### Embodiment

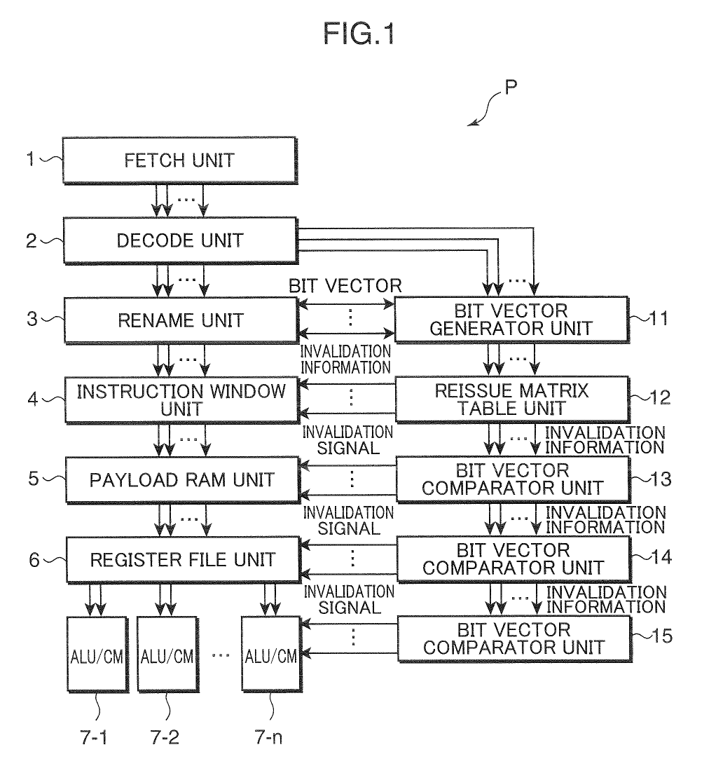

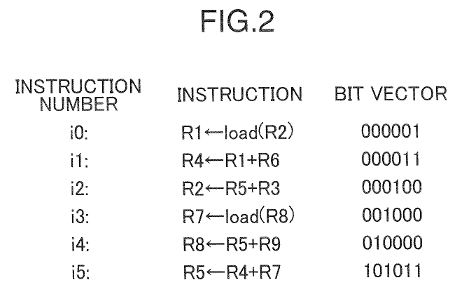

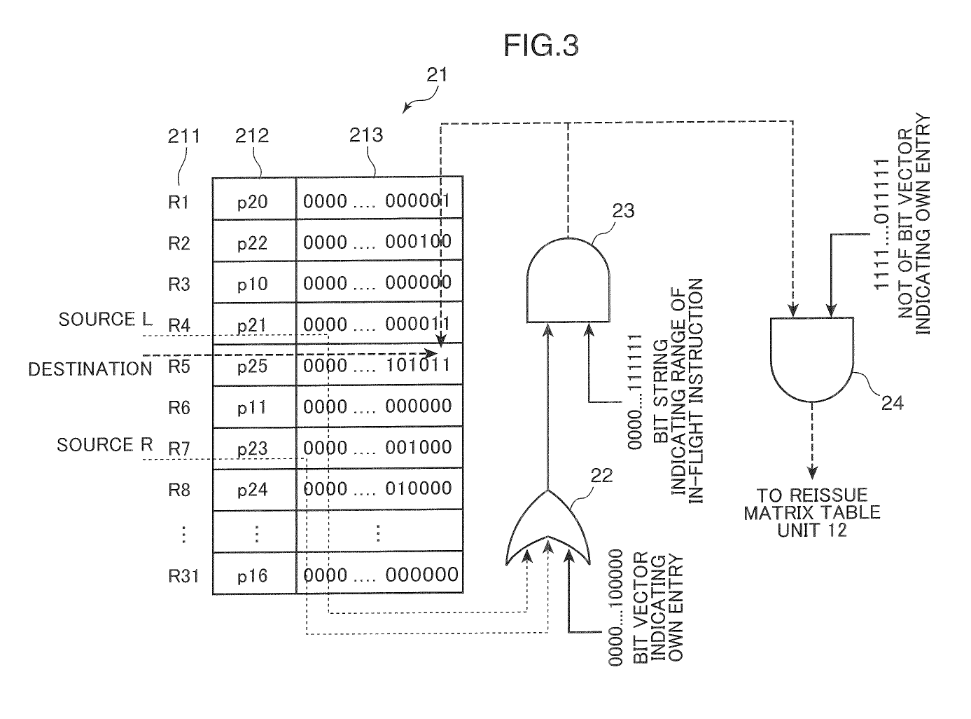

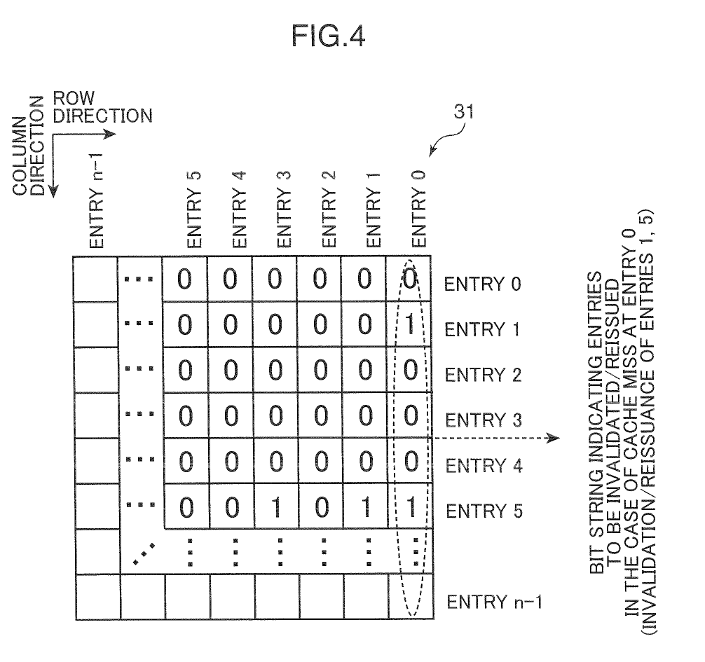

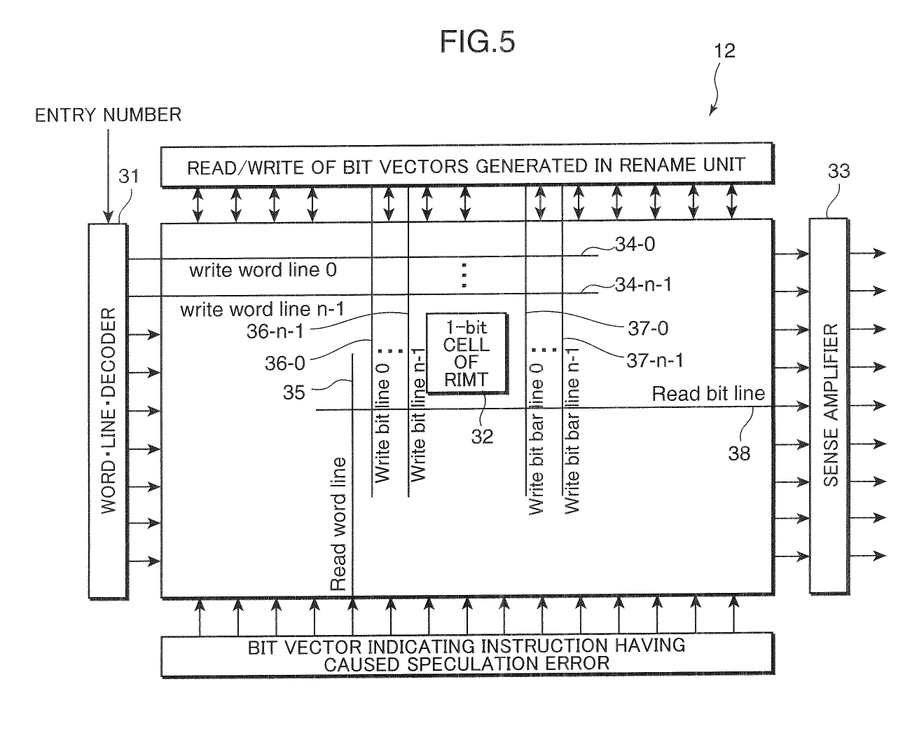

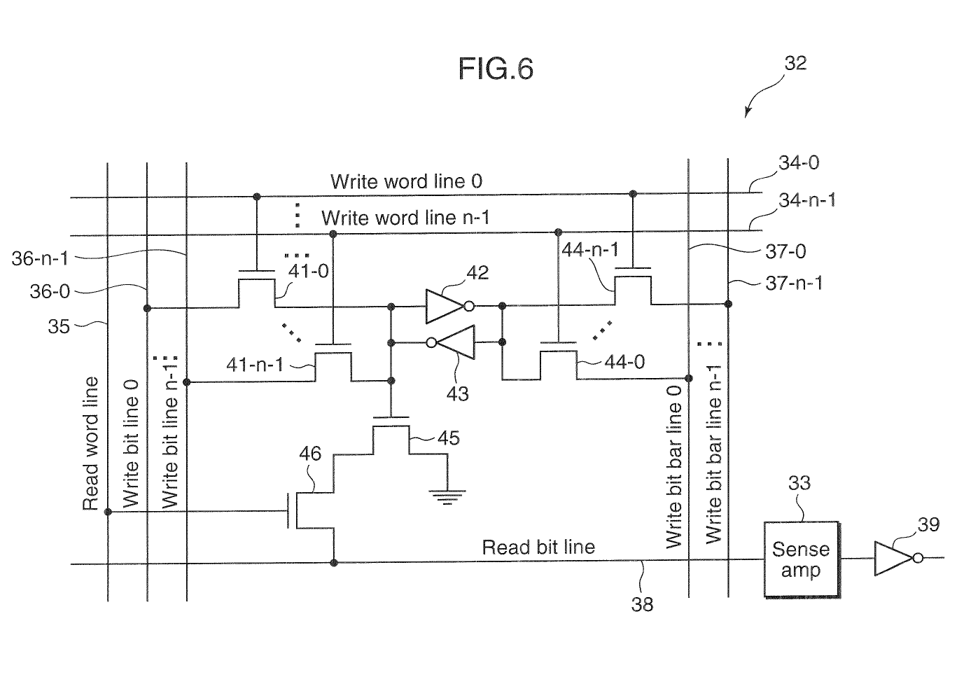

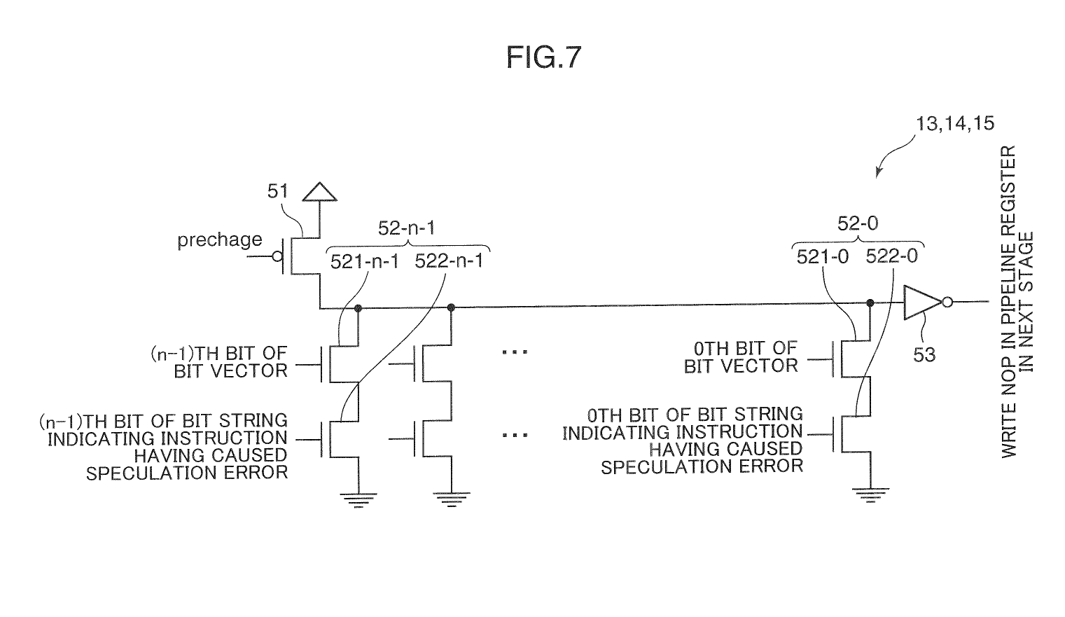

FIG. 1 is a block diagram showing the construction of a microprocessor according to one embodiment of the present invention. FIG. 2 is a table showing a method for generating a bit vector in the embodiment. FIG. 3 is a diagram showing the configuration of a register map table in the embodiment. FIG. 4 is a diagram showing the configuration of a reissue matrix table in the embodiment. FIG. 5 is a block diagram showing an exemplary construction of a reissue matrix table unit. FIG. 6 is a circuit diagram showing 1-bit cells in the reissue matrix table shown in FIG. 5. FIG. 7 is a circuit diagram showing an exemplary construction of a bit vector comparator unit.

The microprocessor according to this embodiment is for pipeline processing the execution of instructions and is provided with a scheduling unit for scheduling an issue order of a plurality of instructions, a dependency relationship information storage storing dependency relationship information representing a dependency relationship of each of the plurality of instructions with all the preceding instructions, and a judging unit for judging whether or not the instruction in each stage after instruction issue depends on the instruction of a miss speculation based on the dependency relationship information if the miss speculation occurs during the execution of the plurality of instructions in accordance with the schedule set by the scheduling unit.

In the microprocessor thus constructed, the dependency relationship information representing the dependency relationship of each of the plurality of instructions with all the preceding instructions is stored in the dependency relationship information storage, and the judging unit judges whether or not the instruction in each stage after the instruction issue depends on the instruction of the miss speculation based on the dependency relationship information if the miss speculation occurs during the execution of the plurality of scheduled instructions.

Thus, in the microprocessor thus constructed, it is possible to properly select not only the instructions directly dependent on the instruction of the miss speculation, but also those indirectly dependent on the instruction of the miss speculation. Accordingly, the microprocessor thus constructed can selectively invalidate only the instructions dependent on the instruction of the miss speculation and can selectively reissue only such instructions. Therefore, the microprocessor thus constructed can perform a recovery processing for invalidating only the instructions in a dependency relationship at once in the case of a miss speculation in speculative scheduling.

In the microprocessor with the above construction, the scheduling unit is preferably an instruction window unit for selecting executable instruction(s) from one or more stored instructions, scheduling the selected instruction(s) while assigning entry number(s) thereto and issuing the instruction(s) in accordance with the set schedule, and the dependency relationship information is a bit vector comprised of a bit string representing whether or not each bit is in a dependency relationship with the instruction of the entry number of the instruction window unit corresponding to the bit number of this bit.

Further, in the microprocessor thus constructed, the dependency relationship information storage preferably stores a reissue matrix table comprised of a two-dimensional matrix, in which a plurality of bit vectors relating to the plurality of instructions are arranged by being written in a row direction in rows of the entry numbers corresponding to the instructions of the bit vectors, and outputs a column of the entry number corresponding to the instruction having caused the miss speculation in a column direction to the judging unit in the case of the miss speculation.

The microprocessor P for pipeline processing the execution of such instructions is, for example, provided with a fetch unit 1, a decode unit 2, a rename unit 3, an instruction window unit 4, a payload RAM unit 5, a register file unit 6, a plurality of arithmetic logic units or cache memories (ALU/CM) 7 (7-1 to 7-n), a bit vector generator unit 11, a reissue matrix table unit 12 and bit vector comparator units 13, 14 and 15 as shown in FIG. 1.

The instruction window unit 4 is an example of the above scheduling unit, the reissue matrix table unit 12 is an example of the above dependency relationship information storage and the bit vector comparator units 13, 14 and 15 are an example of the above judging unit.

In this specification, constituents are identified by reference numerals without suffixes in the case of being collectively termed while being identified by reference numerals with suffixes in the case of being individually termed.

The fetch unit 1 is a circuit connected with the decode unit 2 and adapted to fetch an instruction (machine instruction) (fetch an instruction from a memory) and output the fetched instruction to the decode unit 2.

The decode unit 2 is a circuit connected with the rename unit 3 and the bit vector generator unit 11 and adapted to decode the instruction (interpret the meaning of the instruction). The decode unit 2 outputs this decoded instruction to the rename unit 3 and the bit vector generator unit 11.

The rename unit 3 is a circuit connected with the instruction window unit 4 and adapted to register renaming to the instruction inputted from the decode unit 2. In this register renaming, the rename unit 3 refers to a register map table stored in an unillustrated register map table unit to convert a logical register number into a physical register number corresponding to this logical register number. A register map table 21 is, for example, a table showing a correspondence between logical register numbers 211 and physical register numbers 212 as shown in FIG. 3. In this embodiment, bit vectors 213 are also related to the logical register numbers 211 and the register map table 21 also shows a correspondence between the logical register numbers 211 and the bit vectors 213 (see FIG. 3) as described later. In this way, the register map table 21 of this embodiment is extended as compared to conventional register map table. The rename unit 3 converts this logical register number into a physical register number and outputs the register-renamed instruction to the instruction window unit 4.

The instruction window unit 4 is a circuit connected with the payload RAM unit 5 and adapted to store one or more instructions inputted from the rename unit 3, select instruction(s) executable by an out-of-order processing from the stored instruction(s), schedule (including speculative scheduling) the selected instruction(s) by assigning entry number(s) in an issue order and issue instruction(s) in accordance with the set schedule. The instruction window unit 4 outputs the issued instruction to the payload RAM unit 5. The instruction window unit 4 attaches a bit vector read from the reissue matrix table unit 12 to be described later and corresponding to this instruction upon outputting the instruction to the payload RAM unit 5. In the case of receiving invalidation information from the reissue matrix table unit 12, the instruction window unit 4 also invalidates the instruction(s) indicated by this invalidation information and reissue the instruction(s) (rescheduling).

The payload RAM unit 5 is a circuit connected with the register file unit 6 and adapted to store instruction information and read the instruction information corresponding to the instruction inputted from the instruction window unit 4. The payload RAM unit 5 outputs the read instruction information to the register file unit 6. This payload RAM unit 5 also attaches the bit vector, which was attached to this instruction, upon outputting the instruction information to the register file unit 6.

The register file unit 6 is a circuit connected with the plurality of ALU/CM7 and including a plurality of registers. The register file unit 6 outputs register data to the ALU/CM7 according to the content of the instruction inputted from the payload RAM unit 5. This register file unit 6 also attaches the bit vector, which was attached to this instruction, upon outputting the register information to the ALU/CM7.

The ALU/CM7 are arithmetic logic units or cache memories. The arithmetic logic unit (ALU) is an arithmetic circuit for computing data inputted from the register file unit 6. The cache memory (CM) is a storage circuit provided in the microprocessor P for storing data operable at a relatively high speed. The cache memory caches the data stored from the register file unit 6. The cache memory may include a primary cache memory operable at a higher speed and adapted to read data at first and a secondary cache memory having a larger storage capacity and adapted to read the data following the primary cache memory.

Although the microprocessor P includes pipeline registers for temporarily saving data such as flip-flops between the respective units, i.e. the fetch unit 1, the decode unit 2, the rename unit 3, the instruction window unit 4, the payload RAM unit 5 and the register file unit 6, these pipeline registers are not shown in FIG. 1.

The bit vector generator unit 11 is a circuit connected with the reissue matrix table unit 12 and adapted to generate a bit vector representing a dependency relationship among the instructions based on the instructions inputted from the decode unit 2. The bit vector is a bit string made up of as many bits as the entry numbers of the instruction window unit 4, and each bit of this bit vector represents the dependency relationship with the instruction in the entry number of the instruction window unit 4 corresponding to the bit number of this bit, for example, by setting “1”. The bit vectors are provided for the respective entries of the instruction window unit 4 and the respective pipeline registers up to a stage having a possibility of invalidating and reissuing the instruction after issue. By this bit vector, not only the dependency relationship with one previous instruction, but also the dependency relationship with all the preceding instructions in the instruction window unit 4 can be represented. Although the bit corresponding to the entry number of its own is “0” in the bit vector, it is set to “1” as follows in the process of generating the bit vector.

This bit vector is generated as follows. Here, this is described, using a sequence of instructions shown in FIG. 2 as an example. FIG. 2 shows instruction numbers, instructions and bit vectors from left to right. It should be noted that the bit corresponding to the entry number of its own is set to “1” in the bit vector generator unit 11 to simplify the generation of the bit vector.

In this sequence of instructions shown in FIG. 2, an instruction i0 of an instruction number i0 (hereinafter, merely “instruction i0”) is R1←load (R2) and has no dependency relationship with preceding instructions. Thus, “1” is set only for the 0^{th} bit corresponding to the entry number “0” of its own. Thus, the bit vector of the instruction i0 is “0000 . . . 000001”. An instruction i1 is R4←R1+R6 and has a dependency relationship with the preceding instruction i0. Thus, “1” is set only for the 0^{th} bit corresponding to the entry number “0” of the instruction i0 and the 1^{st} bit corresponding to the entry number “1” of its own. Thus, the bit vector of the instruction i1 is “0000000011”. An instruction i2 is R2←R5+R3 and has no dependency relationship with the preceding instructions. Thus, “1” is set only for the 2^{nd} bit corresponding to the entry number “2” of its own. Thus, the bit vector of the instruction i2 is “000000 . . . 0100”. An instruction i3 is R7←load (R8) and has no dependency relationship with the preceding instructions=Thus, “1” is set only for the 3^{rd} bit corresponding to the entry number “3” of its own. Thus, the bit vector of the instruction i3 is “0000 . . . 001000”. An instruction i4 is R8←R5+R9 and has no dependency relationship with the preceding instructions. Thus, “1” is set only for the 4^{th} bit corresponding to the entry number “4” of its own. Thus, the bit vector of the instruction i4 is “0000-010000”. An instruction i5 is R5←R4+R7 and has a dependency relationship with the preceding instructions i1 and i3 and further with the instruction i0 via the instruction i1. Thus, “1” is set only for the 0^{th}, 1^{st} and 3^{rd} bit corresponding to the entry numbers “0”, “1” and “3” of the instructions i0, i1 and i3 and the 5^{th} bit corresponding to the entry number “5” of its own. Thus, the bit vector of the instruction i1 is “0100 . . . 101011”.

In this way, the bit vector is generated by taking a logical sum (“OR”) of the bit vector having “1” set in the bit corresponding to the entry number of its own and the bit vector(s) of the instruction(s) “in” in a direct dependency relationship with the instruction of this bit vector in the case of setting “1” in the bit corresponding to the entry number of its own. In the case of requiring a complicated computation upon obtaining a dependency relationship between the instructions, it may possibly rather reduce the processing efficiency of the microprocessor P. However, the microprocessor P can obtain bit vectors representing the dependency relationships among the instructions by a relatively simple computation in this way

Such bit vectors are generated by a bit vector generating circuit, for example, including the unillustrated register map unit storing the register map table 21, an OR circuit 22 and an AND circuit 23 as shown in FIG. 3. The OR circuit 22 is a circuit, to which the bit vector of the instruction “in” in a dependency relationship with the instruction of the bit vector to be generated is inputted from the register map 21 and the bit vector having “1” set in the bit corresponding to the entry number of its own is inputted and which performs an OR operation of these inputted bit vectors. The AND circuit 23 is a circuit, to which the output of the OR circuit 22 is inputted, a bit string representing the range of an in-flight instruction (instruction being executed on the processor) is inputted and which performs an AND operation of these inputted bit vector and bit string. The computational result of the AND circuit 23 is the above bit vector and is necessary for the generation of other bit vectors, wherefore it is written in an entry corresponding to a destination logical register and saved in the register map table 21. There is no likelihood that the instruction is invalidated by the already executed instruction, and the description of dependency on the already executed instructions is eliminated from the bit vector by the AND circuit 23 in consideration of the in-flight instruction. Since the entries of the instruction window unit 4 are reused, the dependency information on the instructions having previously occupied the entries is also eliminated from the bit vector by the AND circuit 23. In FIG. 3, it is shown by thin broken line that the instruction (destination) to generate the bit vector, e.g. the bit vector corresponding to source logical register numbers (source T and source R) of the instruction i5 of the sequence of instructions “in” shown in FIG. 2 is read from the register map table 21 and the read bit vector is inputted to the OR circuit 22 and it is shown by heavy broken line that the bit vector obtained in the AND circuit 23 is saved in the register map table 21.

Although the bit indicating the own entry in the bit vector is necessary in the case of generating a bit vector using the register map table 21, it is not necessary in the case of judging whether or not to invalidate upon the occurrence of a miss speculation. Thus, in FIG. 3, there is also shown an AND circuit 24, to which the negation (NOT) of the bit vector indicating the own entry is inputted when the output of the AND circuit 24 is inputted and which performs an AND operation of these bit vectors. The AND circuit 24 generates a bit vector having the bit “1” representing the dependency relationship with itself eliminated by replacing the bit corresponding to the own entry number by “0” and outputs this bit vector to the reissue matrix table unit 12.

This bit vector needs to be generated before the instruction fetched by the fetch unit 1 is inputted to the instruction window unit 4 via the decode unit 2 and the rename unit 3. In this embodiment, the bit vector 213 is generated in parallel with the register renaming of the rename unit 3 and saved (registered) in the register map table 21 while being related to the logical register number 211 corresponding to the instruction of the bit vector 213 (saved in the unillustrated register map unit).

Speculative scheduling is performed using such bit vectors and, upon the occurrence of a miss speculation, only the instructions in the dependency relationship can be selectively invalidated at once and rescheduling can be performed for a recovery processing without invalidating all the instructions issued before the occurrence of the miss speculation by invalidating each instruction having the bit vector with the bit corresponding to the entry number of the instruction set to “1” and performing rescheduling (reissue).

The register map table unit 12 is a circuit connected with the instruction window unit 4 and the bit vector comparator units 13, 14 and 15 and adapted to store the dependency relationship information representing the dependency relationship of each of a plurality of instructions with all the preceding instructions and to output invalidation information representing the instructions to be invalidated in the case of a miss speculation. The invalidation information outputted from the reissue matrix table unit 12 to the instruction window unit 4 indicates the instructions to be reissued (rescheduled). The reissue matrix table unit 12 stores, for example, a reissue matrix table (RIMT) 31, in which the dependency relationship information is registered, as shown in FIG. 4 and outputs the invalidation information according to the instruction having caused the miss speculation. In the reissue matrix table 31 shown in FIG. 4, the bit vector generated in the bit vector generator unit 11 is written in a row direction (horizontal direction in the plane of FIG. 4) in a row of the entry number corresponding to the instruction of this bit vector. Thus, the reissue matrix table 31 is comprised of a two-dimensional matrix, in which a plurality of bit vectors corresponding to a plurality of instructions are arrayed. Each bit of the bit vector indicates the dependency relationship with the instruction of the entry number corresponding to the bit number. Thus, in the reissue matrix table 31 shown in FIG. 4, when a miss speculation occurs, the column of the entry number corresponding to the instruction having caused this miss speculation is read in a column direction (vertical direction in the plane of FIG. 4) as the invalidation information The instructions corresponding to the entry numbers, at which “1” is set, of this column (invalidation and reissue information) are invalidated, and the above instructions are reissued (rescheduled) in the instruction window unit 4. The reissue matrix table 31 shown in FIG. 4 stores the bit vectors of the sequence of instructions “in” shown in FIG. 2. For example, if the instruction i0 saved in the entry number “1” experiences a miss speculation in the example shown in FIG. 4, the column of the entry number “0” is read in the column direction, the instructions i1, i5 corresponding to the entry numbers “1” and “5”, at which “1” is set, of this column are invalidated and reissued.

The bit vector comparator units 13, 14 and 15 are circuits provided in correspondence with the respective stages of the instructions issued by the instruction window unit 4 and adapted to judge whether or not the instructions in the respective stages after the instruction issue depend on the instruction of a miss speculation and invalidate the instructions dependent on the instruction of the miss speculation if the miss speculation occurs during the instruction execution. The bit vector comparator units 13, 14 and 15 compare the bit vectors of the instructions and the bit string of the invalidation information outputted from the reissue matrix table unit 12 in the respective stages of the instructions issued by the instruction window unit 4 and, if there is any coinciding bit, output a command (invalidation signal) to write a NOP instruction in the pipeline register in the next stage for the invalidation of the instruction corresponding to the coinciding bit. With the NOP (no-operation) instruction, no operation is performed. The bit vector comparator unit 13 is connected with the payload RAM unit 1 and invalidates the stage of the payload RAM unit 5. The bit vector comparator unit 14 is connected with the register file unit 6 and invalidates the stage of the register file unit 6. The bit vector comparator unit 15 is connected with ALU/CM7 and invalidates the stage of the ALU/CM7.

In such a microprocessor P, an instruction is fetched by the fetch unit 1 and this fetched instruction is outputted to the decode unit 2. In the decode unit 2, the instruction is interpreted and this interpreted instruction is outputted to the rename unit 3 and the bit vector generator unit 11. In the rename unit 3, this instruction is register-renamed and this register-renamed instruction is outputted to the instruction window unit 4. In the bit vector generator unit 11, in parallel with the register renaming of this rename unit 3, a bit vector is generated based on the instruction and saved in the register map table 21 of the unillustrated register map unit, and a bit vector having the bit “1” indicating the dependency relationship with itself eliminated is generated and outputted to the reissue matrix table unit 12.

In the instruction window unit 4, an out-of-order processing is performed to the instruction register-renamed in the rename unit 3, whereby the executable instruction is selected, this selected instruction is scheduled (including speculative scheduling) and assigned with an entry number. The instruction is issued in accordance with this scheduling and this issued instruction is outputted from the instruction window unit 4 to the payload RAM unit 5. At this time, the instruction window unit 4 reads the bit vector corresponding to this instruction from the reissue matrix table 31 of the reissue matrix table unit 12 and attaches to the instruction. This attached bit vector is also attached to the instruction in the respective stages after the instruction issue. In the payload RAM unit 5, the instruction information corresponding to the instruction outputted from the instruction window unit 4 is read and this read instruction information is outputted to the register file unit 6 together with the bit vector. In the register file unit 6, register data is outputted to the ALU/CM7 together with the bit vector according to the content of the instruction. In the ALU/CM7, the data is computed if the ALU/CM7 are arithmetic logical units, whereas reading or writing from or in an address represented by the data is performed if the ALU/CM7 are cache memories.

Here, if a miss speculation occurs in the schedule set in the instruction window unit 4, the invalidation information is outputted from the reissue matrix table unit 12 to the instruction window unit 4 and the bit vector comparator units 13, 14 and 15. In the instruction window unit 4, upon receiving the invalidation information, each instruction indicated by the invalidation information is invalidated and reissued (rescheduled) In the bit vector comparator units 13, 14 and 15, each instruction to be invalidated due to the miss speculation is judged based on the invalidation information in each stage and invalidation signals are outputted to the payload RAM unit 5, the register file unit 6 and the ALU/CM7 for invalidation.

Since the microprocessor P of this embodiment operates in this way, if a miss speculation occurs during the instruction execution in accordance with the schedule speculatively set in the pipeline processing, it is possible to selectively invalidate and selectively reissue only the instructions in a dependency relationship with the instruction of this miss speculation by referring to the reissue matrix table 31 of the reissue matrix table unit 12. Such selective invalidation and reissue can be performed not only for the instructions in a direct dependency relationship, but also those in an indirect dependency relationship as can be understood from the above bit vector generating method. Accordingly, the microprocessor P of this embodiment can perform a recovery processing for quickly invalidating only the instructions in a dependency relationship at once if a miss speculation occurs in speculative scheduling.

Since only the instructions in a dependency relationship with the instruction of the miss speculation are selectively invalidated and reissued in this way, a reduction in the performance of the microprocessor P due to reissue can be suppressed to a minimum level and the power consumption of the microprocessor P can be reduced as compared to the background technology.

An exemplary construction of the reissue matrix table unit 12 may be as shown in FIG. 5. In FIG. 5, the reissue matrix table unit 12 includes a word line decoder 31 for decoding a word line used to read and write a bit vector generated in the renaming stage, a plurality of 1-bit cells 32 each for saving one bit in the reissue matrix table 31, and a sense amplifier 33 for amplifying a signal upon reading the data of the 1-bit cell 32 to quickly determine 0/1 of the signal. The respective 1-bit cells 32 are connected with a plurality of write word lines 34 (34-0 to 34-n) extending from the word line decoder 31, a read bit line 38 extending to the sense amplifier 33, a read word line 35 used to input a bit vector indicating an instruction having caused a miss speculation, a plurality of write bit lines 36 (36-0 to 36-n−1) and a plurality of write bit bar lines 37 (37-0 to 37-n−1) used to read and write a bit vector generated in the rename stage. The reissue matrix table unit 12 thus constructed has substantially the same construction as RAMs, but differs therefrom in that the directions of the respective bit lines are different by 90° and no decoder is necessary for the bit lines. In the reissue matrix table unit 12 thus constructed, data are written in a row direction upon reading a bit vector generated in the rename stage, and data are read in a column direction upon reading a bit vector indicating the invalidation information. In this way, the reissue matrix table unit 12 has substantially the same construction as RMs and can be relatively easily manufactured using general semiconductor manufacturing technology.

An exemplary 1-bit cell 32 in the reissue matrix table unit 12 shown in FIG. 5 may be as shown in FIG. 6. In FIG. 6, the 1-bit cell 32 includes a plurality of switching elements 41 (41-0 to 41-n−1) with control terminals, inverters 42, 43, a plurality of switching elements 44 (44-0 to 44-n−1) with control terminals and switching elements 45, 46 with control terminals. Each of the switching elements 41 to 46 with control terminals is, for example, a transistor such as a MOS transistor. If the respective switching elements 41 to 46 with control terminals are MOS transistors, the gate terminals of the plurality of MOS transistors 41-0 to 41-n−1 are respectively connected with the write word lines 34-0 to 34-n−1, the source terminals thereof are respectively connected with the write bit lines 36-0 to 36-n−1 and the drain terminals are connected with the input terminal of the inverters 42 and the output terminal of the inverter 43. The input terminal of the inverter 42 is connected with the output terminal of the inverter 43, and the output terminal of the inverter 42 is connected with the input terminal of the inverter 43. The gate terminals of the plurality of MOS transistors 44-0 to 44-n−1 are respectively connected the write word lines 34-n−1 to 34-0, the source terminals thereof are respectively connected with the output terminal of the inverter 42 and the input terminal of the inverter 43, and the drain terminals thereof are respectively connected with the write bit bar lines 36-0 to 36-n−1. Further, the gate terminal of the MOS transistor 46 is connected with the read word line 35, the source terminal thereof is connected with the read bit line 38 and the drain terminal thereof is connected with the source terminal of the MOS transistor 45. The gate terminal of the MOS transistor 45 is connected with the drain terminals of the respective MOS transistors 41-0 to 41-n−1 (connected with the input terminal of the inverter 42 and the output terminal of the inverter 43), and the drain terminal thereof is grounded. In the 1-bit cell 32 thus constructed, the read bit line 38 at a read port discharges due to pull-down stack when the value (data) of the 1-bit cell 32 is “1”, thereby changing to “0”, and the sense amplifier 33 loads, amplifies and outputs this data “0”. This data “0” is converted into “1” by a NOT gate 39 (not shown in FIG. 5) connected with the output of the sense amplifier 33 and this data “1” is outputted. By adopting such a wired OR construction, it is possible to compile the reading of a plurality of bit vectors in the column direction and the OR operation of the bit vectors when a plurality of miss speculation occur.

An exemplary construction of the bit vector comparator unit 13, 14 and 15 may be as shown in FIG. 7. In FIG. 7, each of the bit vector comparator unit 13, 14 and 15 includes a switching element 51 with a control terminal, a plurality of bit comparison circuits 52 each comprised of two first and second switching elements 521 (521-0 to 521-n−1), 522 (522-0 to 522-n−1) with control terminals connected in series, and an inverter 53. The respective switching elements 51, 521 and 522 with control terminals are, for example, transistors such as MOS transistors. If the switching elements 51, 521 and 522 with control terminals are MOS transistors, the gate terminal of the MOS transistor 51 has a precharge signal inputted thereto, the source terminal thereof is connected with a power supply having a specified voltage value, and the drain terminal thereof is connected with the input terminal of the inverter 53. The output terminal of the inverter 53 is connected with the pipeline register in the next stage to write a NOP instruction in the pipeline register in the next stage. As many bit comparison circuits 52-0 to 52-n−1 as the bit number of the bit vector are prepared to correspond to the respective bits of the bit vector. In the respective bit comparison circuits 52-0 to 52-n−1, the source terminals of the first MOS transistors 521-C to 521-n−1 are connected between the drain terminal of the MOS transistor 51 and the input terminal of the inverter 53, the drain terminals of the first MOS transistors 521-0 to 521-n−1 are connected with the source terminals of the second MOS transistors 522-0 to 522-n−1, and the drain terminals of the second MOS transistors 522-0 to 522-n−1 are grounded. The bits of the bit vector corresponding to the bit comparison circuit 52 are inputted to the gate terminals of the first MOS transistors 521-0 to 521-n−1, and the bits of the bit string representing the instruction having caused the miss speculation corresponding to the bit comparison circuit 52 are inputted to the gate terminals of the second MOS transistors 522-0 to 522-n−1. In the bit vector comparator units 13, 14 and 15 thus constructed, the bits of the bit vector and those of the bit string indicating the instruction having caused the miss speculation can be compared at high speed since the bit comparison circuit 52 is a dynamic circuit. Therefore, even if the bit number of the bit vector is large to make the bit vector length longer, it can be dealt with.

### (Simulation)

Concerning the microprocessor of this embodiment, simulation was carried out to measure the reissue of all the instructions and the selective reissue by changing an out-of-order execution simulator in the SimpleScalar Tool Set. The SimpleScalar Tool Set is disclosed, for example, “Burger, D. and Austin, T. M. “The SimpleScalar Tool Set, Version 2.0”, Technical Report CS-TR-97-1342, University of Wisconsin-Madison Computer Sciences Dept. (1997)”.

The construction of a microprocessor in this simulation is as follows. A processor core has an issue width of 8, a RUU of 128 entries, an LSQ of 64 entries, 8 int ALU, 4 int mlut/div, 8 fp ALU, 4 fp mlut/div and 8 memory ports. Branch prediction is gshare with 8K entries PHT and a history length of 6, BTB with 2K entries, and BAS with 16 entries. L1 I-cache and L1 D-cache have a hit latency of 3 cycles in 64 KB/32B-line/2-way, an L2 unified cache has a hit latency of 24 cycles in 2 MB/64B-line/4-way. A memory has a transfer interval of 2 cycles in initial reference of 128 cycles. TLB has 16 entries for instructions, 32 entries for data and a miss latency of 134 cycles.

In this simulation, a SimpleScalar PISA was used as an instruction set, and 8 int and 9 fp programs of SPEC2000 were used as benchmark programs. A train or ref was used as an input, the first 1 G instructions were skipped and the subsequent 1.5 G instructions were measured.

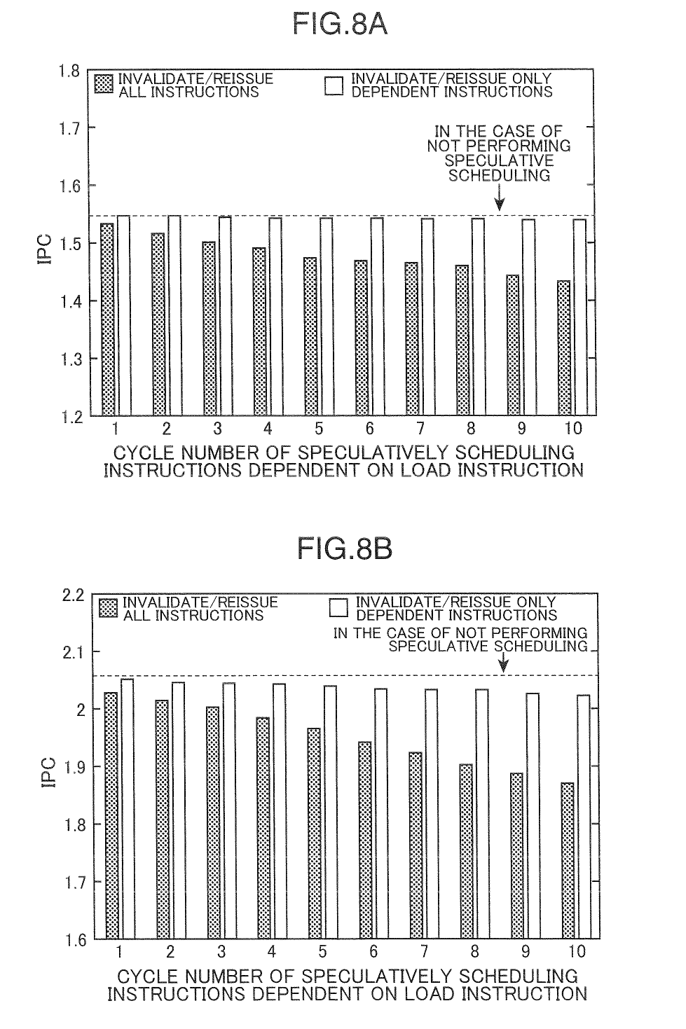

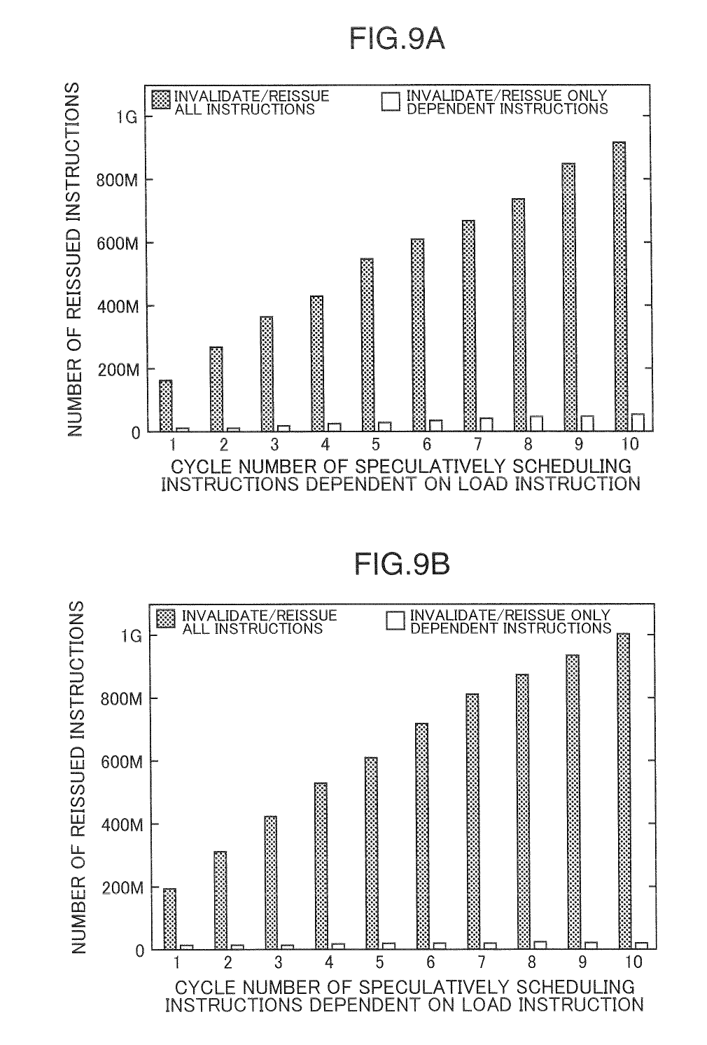

FIGS. 8 and 9 are graphs showing simulation results

FIG. 8 show benchmark average IPCs in the case where the cycle number of speculatively scheduling instructions dependent on a load instruction was changed due to an increase in instruction issue latency, wherein FIG. 8A shows the case of SPECint2000 and

FIG. 8B shows the case of SPECfp2000. A horizontal axis of FIG. 8 represents the cycle number of speculative scheduling and a vertical axis thereof represents IPC (number of instructions executed per cycle) FIG. 9 are graphs showing benchmark average number of instructions reissued in the case where the cycle number of speculatively scheduling instructions dependent on a load instruction was changed due to an increase in instruction issue latency, wherein FIG. 9A shows the case of SPECint2000 and FIG. 9B shows the case of SPECfp2000. A horizontal axis of FIG. 9 represents the cycle number of speculative scheduling and a vertical axis thereof represents the number of reissued instructions. In FIGS. 8 and 9, hatched bars indicate the case of invalidating all the instructions issued in the cycle of speculative scheduling in the case of a miss speculation, and white bars indicate the case of selectively invalidating only the instructions dependent on the load instruction in the case of a miss speculation.

As can be understood from FIG. 8, as the cycle number of speculative scheduling increases, the IPC decreases both in the case of invalidating all the instructions and in the case of selectively invalidating the instructions. The decrease of the IPC is drastically smaller in the case of selectively invalidating the instructions than in the case of invalidating all the instructions. For example, if the cycle number of speculative scheduling is 7, the IPC decreases by 5.3% with int and by 6.2% with fp in the case of invalidating all the instructions, but the decrease of the IPC is suppressed to 0.4% with int and to 1.0% with fp in the case of selectively invalidating the instructions.

As can be understood from FIG. 9, as the cycle number of speculative scheduling increases, the number of instructions to be reissued increases both in the case of invalidating all the instructions and in the case of selectively invalidating the instructions. However, the number of instructions to be reissued is drastically smaller in the case of selectively invalidating the instructions than in the case of invalidating all the instructions. For example, if the cycle number of speculative scheduling is 7, the number of instructions to be reissued in the case of selectively invalidating the instructions is only 6.2% with int and 2.8% with fp as compared to the case of invalidating all the instructions.

As described above, the microprocessor P of this embodiment can selectively invalidate and reissue only the instructions in a direct or indirect dependency relationship with the instruction of a miss speculation even if this miss speculation occurs during the instruction execution in the pipeline processing. Accordingly, the microprocessor P of this embodiment can more properly perform a recovery processing in the case of a miss speculation. Since only the instructions in a dependency relationship with the instruction of the miss speculation are selectively invalidated and reissued in this way, a reduction in the performance of the microprocessor P caused by reissue can be suppressed to a minimum level and the power consumption of the microprocessor P can also be reduced as compared to the background technology.

Various modes of technology are disclosed in this specification as described above. Out of these, main technologies are summarized below.

A microprocessor according to one mode for pipeline processing the execution of instructions comprises a scheduling unit for scheduling an issue order of a plurality of instructions; a dependency relationship information storage for storing a dependency relationship information representing a dependency relationship of each of the plurality of instructions with all the preceding instructions; and a judging unit for judging whether or not the instructions in stages after instruction issue depend on the instruction of a miss speculation based on the dependency relationship information if the miss speculation occurs during the execution of the plurality of instructions in accordance with a schedule set by the scheduling unit.

In the microprocessor thus constructed, the dependency relationship information representing the dependency relationship of each of the plurality of instructions with all the preceding instructions is stored in the dependency relationship information storage, and the judging unit judges whether or not the instructions in the respective stages after the instruction issue depend on the instruction of the miss speculation based on the dependency relationship information if the miss speculation occurs during the execution of the plurality of instructions in accordance with the set schedule.

Thus, the microprocessor of the above construction can properly select not only the instructions directly dependent on the instruction of the miss speculation, but also those indirectly dependent on the instruction of the miss speculation Accordingly, the microprocessor of the above construction can selectively invalidate only the instructions dependent on the instruction of the miss speculation and can selectively reissue only such instructions Therefore, the microprocessor of the above construction can perform a recovery processing for invalidating only the instructions in a dependency relationship at once in the case of a miss speculation in speculative scheduling

According to another mode, it is preferable that the scheduling unit is an instruction window unit for selecting executable instruction(s) from one or more stored instructions, scheduling the selected instruction(s) by assigning entry number(s) and issuing the instruction(s) in accordance with the set schedule; and that the dependency relationship information is a bit vector comprised of a bit string indicating whether or not each bit is in a dependency relationship with the instruction of the entry number of the instruction window unit corresponding to the bit number of this bit.

In the case of requiring a complicated computation upon obtaining the dependency relationship information, there is a possibility of rather decreasing the processing efficiency of the microprocessor. However, in the microprocessor of the above construction, the dependency relationship information between the instructions can be obtained by a relatively simple computation using the bit vector of the above construction as the dependency relationship information.

According to still another mode, the dependency relationship information storage stores a reissue matrix table comprised of a two-dimensional matrix, in which a plurality of bit vectors of the plurality of instructions are arrayed by being written in a row direction in the rows of the entry numbers corresponding to the instructions of the bit vectors, and outputs a column of the entry number corresponding to the instruction of the miss speculation in a column direction to the judging unit in the case of the miss speculation.

Since the dependency relationship information storage stores the reissue matrix table comprised of the two-dimensional matrix in the microprocessor of the above construction, the dependency relationship information storage can be constructed similar to so-called RAMs (Random Access Memories) Thus, the dependency relationship information storage can be relatively easily manufactured, using general semiconductor manufacturing technology.

A method according to another mode is used for a microprocessor for pipeline processing the execution of instructions and adapted to encode a bit vector indicating a dependency relationship with all the instructions preceding the instruction, wherein the bit vector is comprised of a bit string indicating whether or not each bit is in a dependency relationship with an instruction of an entry number of an instruction window unit corresponding to the bit number of this bit.

A method according to still another mode is used for a microprocessor for pipeline processing the execution of instructions and adapted to generate a bit vector indicating a dependency relationship with all the instructions preceding the instruction and comprised of a bit string indicating whether or not each bit is in a dependency relationship with an instruction of an entry number of an instruction window unit corresponding to the bit number of this bit, wherein the bit vector is generated by taking a logical sum of the bit vectors of the instructions in a dependency relationship with the instruction of this bit vector.

In the case of requiring a complicated computation upon obtaining the dependency relationship between the instructions, there is a possibility of rather decreasing processing efficiency. However, the bit vector encoding method and the bit vector generating method constructed as above can obtain the dependency relationship between the instructions by a relatively simple computation and are suitably applicable to the microprocessor.

The present application is based on Japanese Patent Application 2008-017363 filed on Jan. 29, 2008, the content of which is included in the present application,

The present invention has been appropriately and sufficiently described above by way of an embodiment with reference to the drawings, but it should be appreciated that a person skilled in the art can easily modify and/or improve the above embodiment. Accordingly, a modified embodiment or improved embodiment carried out by the person skilled in the art should be interpreted to be embraced by the scope as claimed unless departing from the scope as claimed.

What is claimed is:

1. A microprocessor for pipeline processing instruction execution, comprising:
a scheduling unit for scheduling an issue order of a plurality of instructions;
a dependency relationship information storage for storing a dependency relationship information representing a dependency relationship of each of the plurality of instructions with all the preceding instructions; and
a judging unit for judging whether or not the instructions in stages after instruction issue depend on the instruction of a miss speculation based on the dependency relationship information if the miss speculation occurs during the execution of the plurality of instructions in accordance with a schedule set by the scheduling unit.

2. A microprocessor according to claim 1, wherein:
the scheduling unit is an instruction window unit for selecting executable instruction(s) from one or more stored instructions, scheduling the selected instruction(s) by assigning entry number(s) and issuing the instruction(s) in accordance with the set schedule; and
the dependency relationship information is a bit vector comprised of a bit string indicating whether or not each bit is in a dependency relationship with the instruction of the entry number of the instruction window unit corresponding to the bit number of this bit.

3. A microprocessor according to claim 2, wherein the dependency relationship information storage stores a reissue matrix table comprised of a two-dimensional matrix, in which a plurality of bit vectors of the plurality of instructions are arrayed by being written in a row direction in the rows of the entry numbers corresponding to the instructions of the bit vectors, and outputs a column of the entry number corresponding to the instruction of the miss speculation in a column direction to the judging unit in the case of the miss speculation.

4. A method for encoding a bit vector, the method being used for a microprocessor for pipeline processing the execution of instructions and the bit vector indicating a dependency relationship with all the instructions preceding the instruction, wherein the bit vector is comprised of a bit string indicating whether or not each bit is in a dependency relationship with an instruction of an entry number of an instruction window unit corresponding to the bit number of this bit.

5. A method for generating a bit vector, the method being used for a microprocessor for pipeline processing the execution of instructions and the bit vector indicating a dependency relationship with all the instructions preceding the instruction and comprised of a bit string indicating whether or not each bit is in a dependency relationship with an instruction of an entry number of an instruction window unit corresponding to the bit number of this bit, wherein the bit vector is generated by taking a logical sum of the bit vectors of the instructions in a dependency relationship with the instruction of this bit vector.
